(19) United States
(12) Patent Application Publication
(10) Pub. No.: US 2024/0424573 A1
(43) Pub. Date: Dec. 26, 2024

(54) SYSTEMS AND METHODS FOR ADHESIVE-BASED PART RETENTION FEATURES IN ADDITIVELY MANUFACTURED STRUCTURES

(71) Applicant: Divergent Technologies, Inc., Los Angeles, CA (US)

(72) Inventors: Thomas Samuel Bowden, JR., Los Angeles, CA (US); Chukwubuikem Marcel Okoli, Los Angeles, CA (US); Richard Winston Hoyle, Los Angeles, CA (US)

(21) Appl. No.: 18/830,311

(22) Filed: Sep. 10, 2024

Related U.S. Application Data
(62) Division of application No. 16/184,801, filed on Nov. 8, 2018, now Pat. No. 12,115,583.

(51) Int. Cl. B22F 12/88; B22F 10/18; B22F 10/28; B33Y 10/00; B33Y 30/00; B33Y 80/00

(52) U.S. Cl. CPC B22F 12/88; B33Y 10/00; B33Y 30/00; B33Y 80/00; B22F 10/18; B22F 10/28

(57) ABSTRACT

Systems and methods for adhesive-based part retention features in additively manufactured structures are disclosed. A structure includes a first AM part configured to connect to a second part via a primary connection applied to an interface between the first AM part and the second part. The structure includes at least one retention element including a secondary connection. The secondary connection includes a first adhesive configured to secure the first AM part and the second part. The secondary connection may be located to provide a connection between the first AM part and the second part.

This application is a division of U.S. application Ser. No. 16/184,801, filed Nov. 8, 2018, the disclosure of which is incorporated herein by reference in its entirety.

### BACKGROUND

### Field

The present disclosure relates generally to apparatus and techniques in manufacturing, and more specifically to systems and methods for adhesive-based part retention features in additively manufactured structures for use in producing vehicles, boats, aircraft, and other mechanical structures.

### Background

Three-dimensional (3-D) printing, which may also be referred to as additive manufacturing (AM), is a process used to create 3-D objects. The 3-D objects may be formed using layers of material based on digital model data of the object. A 3-D printer may form the structure defined by the digital model data by printing the structure one layer at a time. 3-D printed objects may be almost any shape or geometry.

A 3-D printer may disseminate a powder layer (e.g., powdered metal) on an operating surface. The 3-D printer may then consolidate particular areas of the powder layer into a layer of the object, e.g., by using a laser to melt or sinter the powder of the powder layer together. The steps may be repeated to sequentially form each layer. Accordingly, the 3-D printed object may be built layer by layer to form the 3-D object.

3-D printing is non-design specific, which offers geometric and design flexibility that conventional manufacturing processes cannot. Furthermore, 3-D printing technologies can produce parts with very small feature sizes, and geometries that are either significantly difficult or impossible to produce using conventional manufacturing processes.

Very large components which exceed printer size specifications can be segregated at the design phase, printed in parallel and combined. The versatility of 3D printing and its ability to create highly complex structures is driving its increased adoption by the industry.

However, as the sophistication of the features of the 3-D printed part increases, the production volume would decrease. The production volume also decreases with the increasing size of the 3-D printed component. These practical limitations are often inherent in certain 3-D printing processes, which may rely on slower printing speeds for accurate rendering of complex geometries.

Additive manufacturing (AM) has provided a significant evolutionary step in the development and manufacture of vehicles and other transport structures. For nearly a century prior to the introduction of AM, manufacturers have been relegated to the assembly line technique of vehicle production using conventional machining to construct and assemble vehicle parts. Because the machined parts are generally specific to a vehicle model design, and acquiring new tooling to construct modified parts can be cost prohibitive, manufacturers have had limited flexibility to implement modifications to an established vehicle design. As a result, a manufacturing facility often uses assembly lines that are limited to producing a single vehicle model.

Being non-design specific, AM is capable of enabling construction of an almost unlimited variety of structures having diverse geometrical shapes and material characteristics. Different AM printers can provide these structures using a variety of materials, including metals, alloys, and thermoplastics. In a new infrastructure hereinbefore proposed by Applicant, AM becomes a primary means of developing custom parts. Parts made via traditional machining and casting, together with widely available commercial off-the-shelf (COTS) parts, can be linked together in a modular form via these custom AM structures to form a chassis of a vehicle, the fuselage of an aircraft, body of a sea vessel, and the like. AM modular parts can also be printed that form the interior of the transport structure. Design modifications are straightforward and can be affected by printing modified AM structures, which avoids the expense of acquiring new tooling.

AM may include the manufacture of one or more nodes. A node is a structural member that may include one or more interfaces used to connect to other nodes or spanning components such as tubes, extrusions, panels, and the like. Using AM, a node may be constructed to include additional features and functions, including interface functions, depending on the objectives.

As described above, nodes and other components may be connected together. For example, one or more nodes and/or other components may be connected together to form larger components. Accordingly, individual AM structures often need to be connected together, or individual AM structures often need to be connected to machined or COTS parts, to provide combined structures, e.g., to realize the above modular network or to form a complex interior assembly in a vehicle. Examples include node-to-node connections, node-to-panel connections, node-to-tube connections, and node-extrusion connections, among others. To connect an AM joint member with a vehicle body panel, for example, mechanical connectors (e.g., screws, clamps, etc.) may be used. Alternatively or additionally, an adhesive may be used to form a strong bond. For connecting these parts, a strict tolerance is often required, meaning that the parts must be positioned to fit precisely in an established orientation. For example, the two parts to be adhered may need to be positioned to avoid direct contact with each other in order to mitigate possible galvanic corrosion problems. In general, an adhesive connection between the AM joint member and panel should result in an accurate fit. Thus the AM joint member should not be misaligned with or offset from the body panel, for example, and the parts should remain properly oriented when a permanent bond is established.

When an adhesive is initially applied between two parts, the force of the adhesive creates a positive pressure that tends to separate the two parts. This separation can adversely affect the integrity of the resulting connection, e.g., where the separation causes the parts to shift during manufacturing. Even when an adhesive is correctly applied in a manner that does not cause the parts to separate or misalign, the adhesive often expands or shifts as it is cured. The resulting position of the adhered parts may in that case not comply with the connection as originally intended.

3-D printed components may be used to produce sub-components for various devices or apparatus. The 3-D printed sub-components may need to be attached or connected to other sub-components, including other 3-D printed sub-components, extruded sub-components, COTS parts, or still other sub-components.

### SUMMARY

Several aspects of apparatus for systems and methods for adhesive-based part retention features in additively manufactured structures will be described more fully hereinafter with reference to three-dimensional printing techniques.

One aspect is an apparatus including an additively manufactured node. The apparatus also includes adhesive-based part retention features. Systems and methods for adhesive-based part retention features in additively manufactured structures are disclosed. A structure includes a first AM part configured to connect to a second part via a primary connection applied to an interface between the first AM part and the second part. The structure includes at least one retention element including a secondary connection. The secondary connection includes a first adhesive configured to secure the first AM part and the second part. The secondary connection may be located to provide a connection between the first AM part and the second part.

It will be understood that other aspects of apparatus for adhesive-based part retention features in additively manufactured structures will become readily apparent to those skilled in the art from the following detailed description, wherein it is shown and described only several embodiments by way of illustration. As will be realized by those skilled in the art, the apparatus for bridging is capable of other and different embodiments, and its several details are capable of modification in various other respects, all without departing from the invention. Accordingly, the drawings and detailed description are to be regarded as illustrative in nature and not as restrictive.

### BRIEF DESCRIPTION OF THE DRAWINGS

Various aspects of apparatus for bridging will now be presented in the detailed description by way of example, and not by way of limitation, in the accompanying drawings, wherein:

FIGS. 1A-D illustrate respective side views of an exemplary 3-D printer system;

FIG. 2 is a diagram illustrating an example structure.

FIG. 3 is a diagram illustrating the example structure in an assembled state.

FIG. 4 is a diagram illustrating a portion of the example structure of FIG. 3.

FIG. 5 is a diagram illustrating a portion of the example structure of FIG. 3.

FIG. 6 is a diagram illustrating a portion of the example structure of FIG. 3.

FIG. 7 is a flow diagram of an exemplary process for adhering an AM structure with another structure.

### DETAILED DESCRIPTION

The detailed description set forth below in connection with the drawings is intended to provide a description of exemplary embodiments of the present invention. The description is not intended to represent the only embodiments in which the invention may be practiced. The terms “exemplary” and “example” used throughout this disclosure mean “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form or may be shown not drawn to scale, or omitted entirely, in order to avoid obscuring the various concepts presented throughout this disclosure.

The present disclosure is directed to adhesive based part retention features used to hold various structures in place during at least one of application and curing of a primary adhesive for bonding the structures together. The part retention features may, in some examples, be permanent and may form an additional bond in conjunction with the primary adhesive. In other examples, the adhesive based part retention feature may be temporary and may be removed after the primary adhesive bond between the structures is formed. The structures to be bonded together may include, for example, two (or more) additively manufactured (AM) parts, an AM part and a tube, panel, extrusion, or any other type of conventionally-manufactured part, or a COTS part. The disclosure covers the use of an adhesive to bond the parts, including conventional adhesives and also including sealants or other materials that may have adhesive properties.

Conventional attempts to address the problems described herein include the use of standoff tabs. Standoff tabs, however, typically have large and cumbersome profiles that render processing steps more difficult, and are more often than not impracticable for the types of precision manufacturing steps involved in automated adhesive injection.

In various examples, one of the parts involved in the adhesion process is a node. A node is an AM structure that includes a feature, e.g., a surface feature that facilitates sealing, adhering, etc., a socket, a receptacle, etc., for attaching to another structure, e.g., a tube, a panel, etc. In addition to their ability to interconnect different types of structures, nodes can be fabricated to perform a variety of different functions. For example, nodes can be used to route electrical circuitry in vehicles or to enable fluid flow. Nodes can be formed by fusing a powder material. For example, a 3-D printer can melt and/or sinter at least a portion of the powder material in multiple layers to form the node. Nodes may be formed of one or more metal and/or non-metal materials. The node may be formed of a substantially rigid material. The materials in a node may include a metallic material (e.g. aluminum, titanium, stainless steel, brass, copper, Chromoly steel, iron, etc.), a composite material (e.g. carbon fiber, etc.), a polymeric material (e.g. plastic, etc.), a combination of these materials and/or other materials, etc.

Nodes can be particularly useful in joint designs for connecting various parts of complex structures, for example. In some designs, nodes can allow for higher levels of dimensional tolerance acceptance that may be needed when assembling complex structures. Node-based designs can also allow for reduced weight, reduced post-processing, and increased case of assembly. In addition, nodes can be used as sockets to adjust for tolerance in designs, and nodes can be co-printed with other parts, which takes advantage of a unique benefit of 3-D printing to simplify the assembly process.

Nodes can be connected to other nodes, panels, tubes, extrusions, and other parts. The connection may involve a mechanical connection, an adhesive connection, or some combination of the two. In embodiments where a size of the node exceeds the printer size (e.g., the size of the powder bed), the node may be 3-D printed as a plurality of sub-nodes, which may then be combined through adhesion.

Two parts may be adhered together in various ways. Adhesion may be performed manually, semi-automatedly, or automatedly. In the exemplary case of an AM node used in a node-to-panel connection, adhesive, sealant, and/or vacuum ports may be 3-D printed into the AM node to enable an automated constructor to inject adhesive at a preconfigured port. The automated constructor, such as a robot, may use an effector specifically designed to inject adhesive into an injection port. In some cases, only adhesive is injected. In other cases, sealant may be injected to circumscribe the areas to where the adhesive can flow. A vacuum may also be applied in some cases to facilitate the flow of the adhesive into an adhesive region located at an interface between a surface of the AM node and a surface of the panel.

Whether the application of adhesive is performed manually or, by contrast, using automated means, the action of applying the adhesive generally results in a positive pressure being applied to the corresponding structures being adhered, which may result in the separation of the two structures being adhered. This separation, left unaddressed, may result in a combination of structures that is misaligned or otherwise improperly connected, or a wholesale failure of the connection where the parts simply separate far enough to avoid the effect of the adhesive.

Further, with or without the problem of positive pressure upon the application of the adhesive, many or most adhesives expand when curing, especially when being thermally cured. This expansion may similarly result in an improper alignment or other faulty connection of the parts being adhered. For example, the parts may have been designed to be in close proximity and/or actual contact at certain points. The expansion due to curing may cause the parts to separate.

In an aspect of the disclosure, one or more part retention features. The part retention features may be mechanical structures operable for use in securing the two or more parts being connected such as through adhesion. The part retention features may cause the parts being connected to temporarily remain in position during either or both of application or curing of the primary adhesive used to bond the parts. The part retention features may be temporary in nature and may be removed after the adhesion process is complete. Alternatively, the part retention features may be permanent. In the latter case, the features may add no appreciable mass or other adverse effect to the adhered structure, and therefore it may not be necessary to add a removal step to the manufacturing process. The features in some cases may have alternative uses beyond those of part retention.

A number of the part retention features disclosed herein advantageously have flatter profiles than conventional standoff tabs used for similar purposes. Because the features do not stick out and potentially interfere with other adjacent structures, a manufacturing step of removing the features may be avoided. In other cases, a flatter profile means that the structures with smaller part retention features can be more compactly placed in any given area to conduct the adhesion process. In turn, less room is necessary for the part retention features, which features may be ancillary or temporary in nature.

The use of 3-D printing may provide significant flexibility for enabling manufacturers of mechanical structures and mechanized assemblies to manufacture parts with complex geometries. For example, 3-D printing techniques provide manufacturers with the flexibility to design and build parts having intricate internal lattice structures and/or profiles that may not be possible to manufacture via traditional manufacturing processes or may be cost prohibitive to manufacture via traditional manufacturing processes. As discussed above, the 3-D printed sub-components may need to be attached or connected to other sub-components, including other 3-D printed sub-components, extruded sub-components, or still other sub-components.

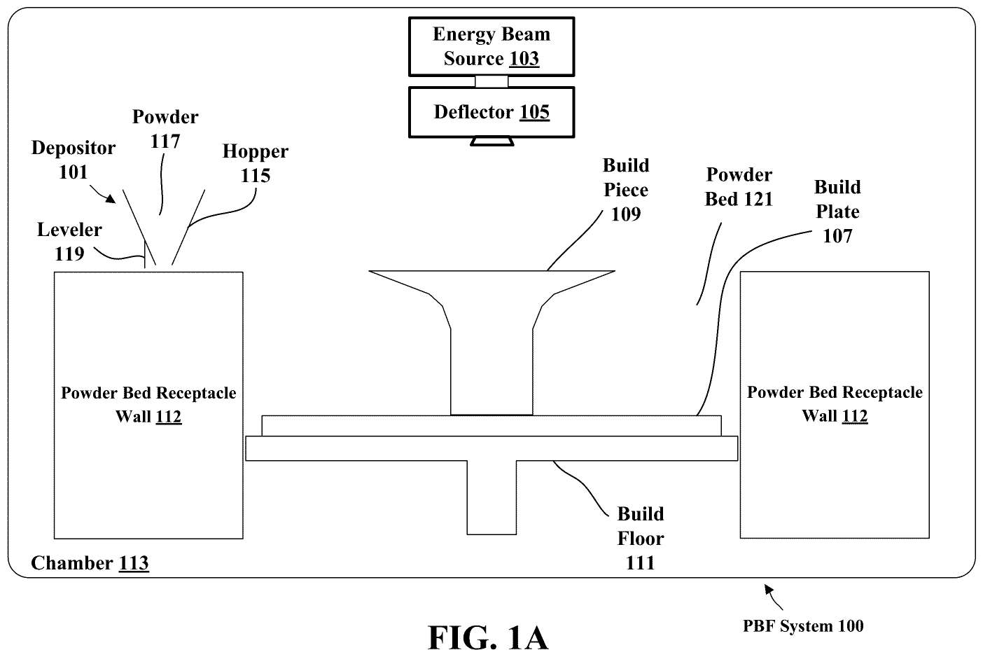

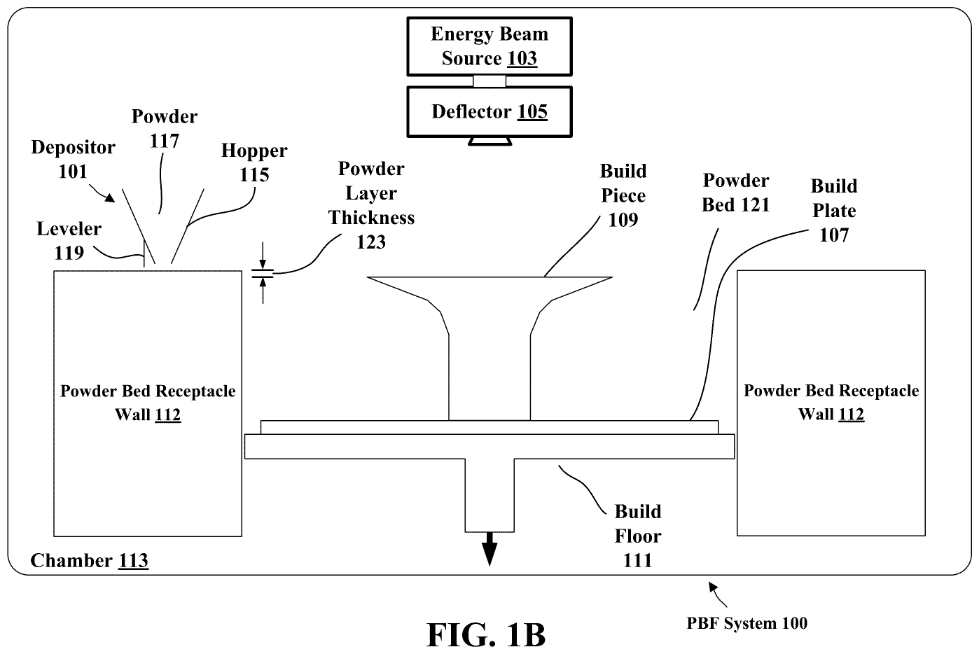

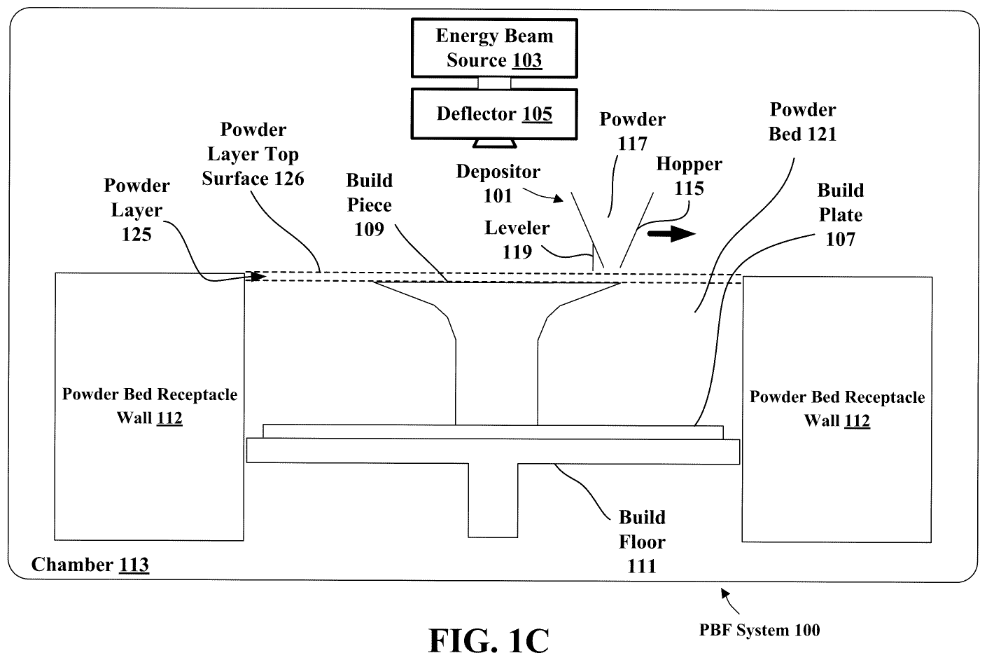

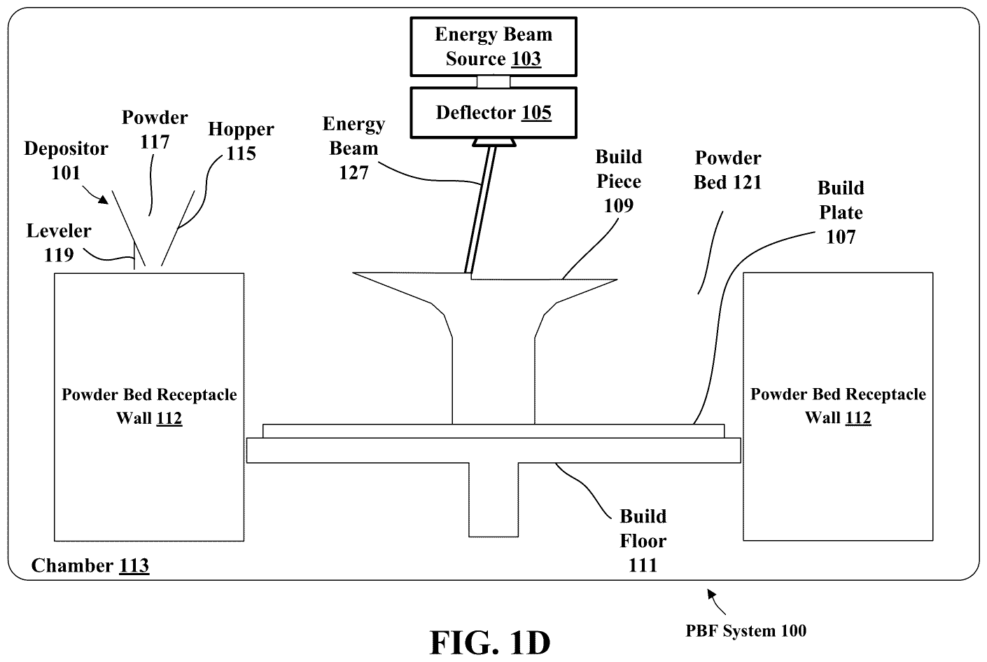

FIGS. 1A-D illustrate respective side views of an exemplary 3-D printer system that may be used to make the AM parts described herein. These AM parts may form sub-components that may need to be attached or connected to other sub-components, including other AM/3-D printed sub-components, extruded sub-components, COTS parts, or still other sub-components. In this example, the 3-D printer system is a powder-bed fusion (PBF) system 100. FIGS. 1A-D show PBF system 100 during different stages of operation. The particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. PBF system 100 can also include a build floor 111 positioned within a powder bed receptacle. The walls 112 of the powder bed receptacle generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit the powder 117 in a space created over the top surfaces of build piece 109 and powder bed 121 and bounded by powder bed receptacle walls 112. In this example, depositor 101 progressively moves over the defined space while releasing the powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case, energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case, the energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

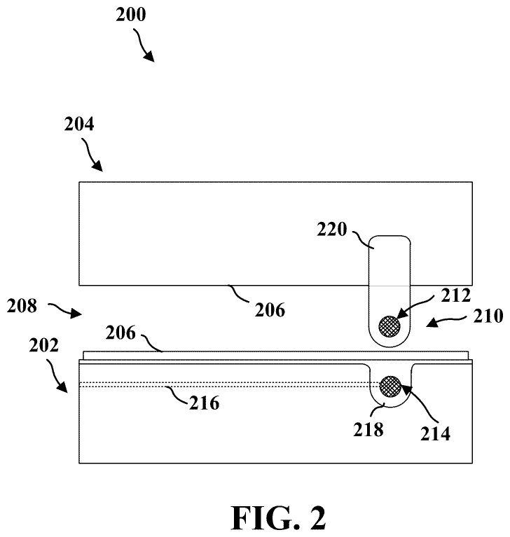

FIG. 2 is a diagram illustrating an example structure 200. The example structure 200 illustrated in FIG. 2 includes a first additively manufactured (AM) part 202 configured to connect to a second part 204 via a primary connection 206 applied to an interface 208 between the first AM part 202 and the second part 204.

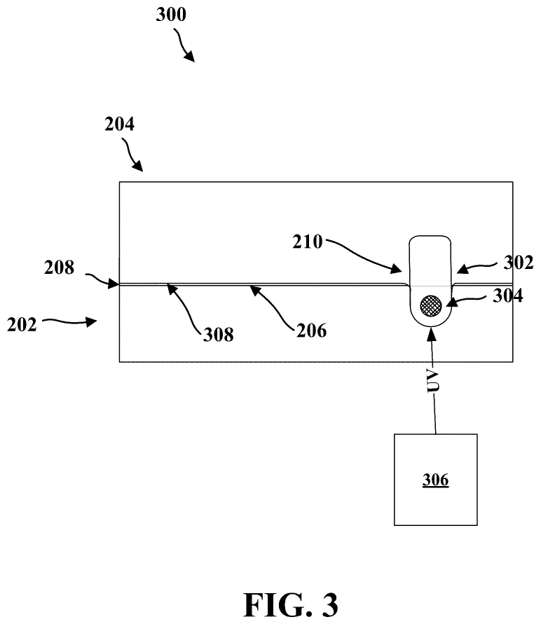

In an aspect, at least one retention element 210 including a secondary connection 302 (see FIG. 3). The secondary connection 302 including a first adhesive 304 (see FIG. 3) configured to secure the first AM part 202 and the second part 204. The secondary connection located to provide a connection between the first AM part 202 and the second part 204.

FIG. 3 is a diagram illustrating the example structure 300 in an assembled state. The example structure 300 illustrated in FIG. 3 includes the first AM part 202 connected to the second part 204 via the primary connection 206 applied to the interface 208 between the first AM part 202 and the second part 204.

In an aspect, the at least one retention element 210 including a secondary connection 302. The secondary connection 302 including a first adhesive 304 configured to secure the first AM part 202 and the second part 204. The secondary connection may be located to provide a connection between the first AM part 202 and the second part 204.

The example structure 200 may include a first additively manufactured (AM) part 202 and at least one retention element 204. The first AM part 202 may be a node, a subcomponent of a node, or other type of component. The AM part 202 may be printed through any conventional means including, for example, via PBF, e.g., as described with respect to FIGS. 1A-D. The PBF printing may be performed using any technology suitable for use in PBF printing. These technologies may include, for example, selective laser melting (SLM), selective laser sintering (SLS), selective heat sintering (SHS), electron beam melting (EBM), direct metal laser sintering (DMLS), and others. In other embodiments, the AM part 202 may be printing using a different 3-D print technology such as fused deposition modeling (FDM). FDM AM may be ideal for printing various plastics, thermoplastics, etc. In general, the AM part 202 may be additively manufactured using any known AM technique or techniques.

One advantage of the use of AM in combining parts is that, due to the design flexibility of AM, the AM part 202 may include various features 212, 214, 216 that may, in turn, be used in conjunction with the adhesive-based part retention. For example, AM may be used to generate features 212, 214 that are adhered together, features 216 that carry adhesive to a location or locations (e.g., primary connection 206 and/or retention element 210, feature 214) where the AM part 202 may be adhered to another part 204, or a combination of both of these (e.g., features 212, 214, 216). Furthermore, adhesive-based part retention may be combined with mechanical-based part retention. For example, primary adhesive-based part retention may be combined with mechanical-based part retention. Secondary adhesive-based part retention (e.g., holding parts together while a primary adhesive is applied, dries, and/or cures) may be combined with mechanical-based part retention. Some combination of primary adhesive-based part retention and secondary adhesive-based part retention may be combined with mechanical-based part retention. Mechanical-based part retention may include, for example, groove that retains a snap-ring, screw and shim, spring-loaded clips, clips, a snap-like part retention element, snap-like part retention feature slidably engaging with a receptacle on an another part, a Christmas tree fastener, magnets, a tongue and groove connection, or other mechanical-based connections.

In an example, the first AM part 202 may be configured to connect to a second part 204. The second part 204 may include, for example, an AM part, a tube, a panel, an extrusion, any other type of conventionally-manufactured part, or a COTS part. Thus, structures formed may be manufactured by bonding together, for example, two (or more) AM parts (e.g., where one AM part may be considered the first AM part), or an AM part (e.g., where the AM part may be considered the first AM part) and a tube, panel, extrusion, or any other type of conventionally-manufactured part, or a COTS part.

The connection between the first AM part 202 and the second part may be via a primary connection. For example, the primary connection may include a primary adhesive for bonding the structures together. The primary connection may be applied to an interface between the first AM part 202 and the second part 204. For example, the primary adhesive may be applied

A part retention feature (e.g., part retention element 210) may, in some embodiments, be temporary and may be removed after the primary adhesive bond between the structures is formed. Adhesive(s) may also be used for the part retention features. For example, at least one retention element may be included. The at least one retention element may include a secondary connection 302. The secondary connection 302 may include an adhesive configured to secure the first AM part 202 and the second part 204. Furthermore, the secondary connection 302 may be located to provide a connection between the first AM part 202 and the second part 204.

In an aspect, the first adhesive includes a hot melt material applied between a first mechanical feature 214 associated with the first AM part 202 and a second mechanical feature 212 associated with the second part 204. The hot melt material may include any form of hot melt adhesive, hot melt glue, or another thermoplastic adhesive. Generally, however, the hot melt adhesive, hot melt glue, or another thermoplastic adhesive may be quick curing such that hot melt adhesive, hot melt glue, or another thermoplastic adhesive. Accordingly, the hot melt material may be a quick curing adhesive or a quick curing sealant.

In an aspect, hot melt material may be used. The hot melt material may be a quick curing adhesive or sealant that may be applied to the mechanical features on two components to be connected. The features may have an increased surface area. The increased surface area may enable sufficient bond strength to retain the two (or more) parts being connected. Once the hot melt retention fluid cures, adhesive may be injected between the nodes being connected. The cured hot melt feature would ensure that the two parts 202, 204 are retained during the adhesive injection process. The retention force (i.e., the force provided by the hot melt holding the two nodes together) would be higher than the adhesive injection force, thereby securely holding the parts 202, 204 in the proper orientation and with the required separation distance to ensure repeatable bonds.

In an aspect, the first adhesive includes an ultraviolet (UV) cured adhesive applied between a first mechanical feature associated with the first AM part 202 and a second mechanical feature associated with the second part. UV cure systems 306 may be utilized as part retention features. In this embodiment, adhesives at the retention features would be UV cured such that they are held in place during the adhesive injection and curing process. The UV cure adhesives would be applied at strategic locations to provide sufficient retention force. The UV cure adhesive would be configured to cure prior to the adhesive injection and curing.

In an aspect, the primary connection 206 between the first AM part 202 and the second part 204 includes a second adhesive 308. For example, a secondary adhesive may be between the first AM part 202 and the second part 204 where the first AM part 202 and the second part 204 meet, e.g., as illustrated in FIG. 3.

In an aspect, the first adhesive 304 is faster curing than the second adhesive 308. For example, as discussed above, hot melt material such as, hot melt adhesive, hot melt glue, or another thermoplastic adhesive that may be quick curing may be used as the first adhesive 304. The second adhesive 308 may cure more slowly.

In an aspect, the secondary connection 302 further includes a mechanical structure (e.g., making up retention element 210). For example, the secondary connection may include both an adhesive and mechanical-based part retention. Mechanical-based part retention may include, for example, groove that retains a snap-ring, screw and shim, spring-loaded clips, clips, a snap-like part retention element, snap-like part retention feature slidably engaging with a receptacle on another part, a Christmas tree fastener, magnets, a tongue and groove connection, or other mechanical-based connections that may be used in addition to the adhesive.

In an aspect, the mechanical structure may be integrated with at least one of the first AM part 202 and the second part 204. For example, mechanical structure 218 may be integrated with the first AM part 202. Mechanical structure 220 may be integrated with the second part 204.

In an aspect, the mechanical structure is co-printed with at least one of the first AM part 202 and the second part 204. For example, mechanical structure 218 may be co-printed with the first AM part 202. Mechanical structure 220 may be co-printed with the second part 204.

In an aspect, the mechanical structure is separate from the first AM part 202 and the second part 204. For example, mechanical structure 218 may be attached to the first AM part 202 after the first AM part 202 is manufactured. Mechanical structure 220 may be attached to the second part 204 after the second part 204 is manufactured.

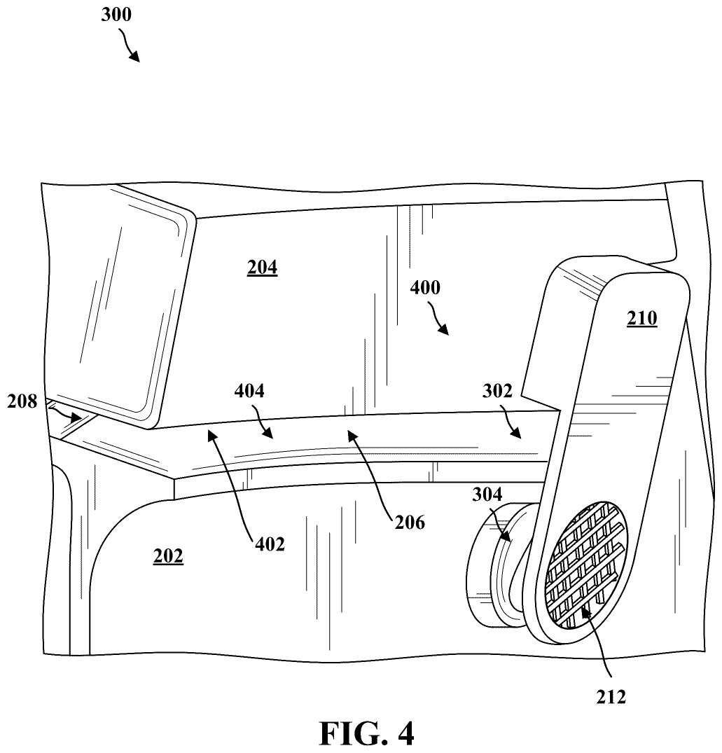

FIG. 4 is a diagram illustrating a portion 400 of the example structure 300 of FIG. 3. The example structure 300 includes the first AM part 202 connected to the second part 204 via the primary connection 206 applied to the interface 208 between the first AM part 202 and the second part 204.

In an aspect, the at least one retention element 210 including a secondary connection 302. The secondary connection 302 including a first adhesive 304 configured to secure the first AM part 202 and the second part 204. The secondary connection may be located to provide a connection between the first AM part 202 and the second part 204.

As illustrated in FIG. 4, the second part 204 may be a node with a groove 402. The first AM part 202 may be a node with a tongue 404. The tongue 404 of the first AM part 202 may insert into the groove 402 of the second part 204, e.g., when the first AM part 202 is assembled with the second part 204 to form a structure. The adhesive 304 may be a hot melt adhesive that may be applied near a hot melt retention feature, e.g., mechanical feature 212, that mates with another retention feature, e.g., mechanical feature 210.

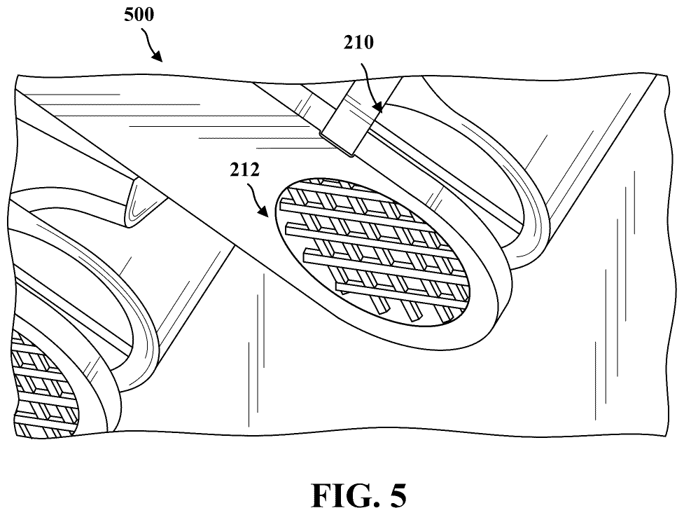

FIG. 5 is a diagram illustrating a portion 500 of the example structure 300 of FIG. 3. More specifically, FIG. 5 illustrates an example of the hot melt retention feature, e.g., mechanical feature 212, that mates with another retention feature, e.g., mechanical feature 210. As illustrated in FIG. 5, the hot melt retention feature, e.g., mechanical feature 212 may be a single bar retention feature. Accordingly, mechanical feature 212 may be a single bar or shaft across an open circular area that forms a retention feature. Additionally, as illustrated in FIG. 5, a hot melt retention feature, e.g., mechanical feature 210 may be a tennis racket or waffle maker retention feature. Accordingly, mechanical feature 210 may be multiple bars or shafts across an open circular area that forms a retention feature generally similar in shape to a tennis racket or hot plate on a waffle maker. Glue or adhesive may be placed between the mechanical feature 210 and the mechanical feature 212. The glue or adhesive may flow in between portions of the mechanical feature 210 and the mechanical feature 212 and may bind to the portions of the mechanical feature 210 and the mechanical feature 212. For example, the glue or adhesive may bind to the single bar retention feature and/or the tennis racket or waffle maker retention features.

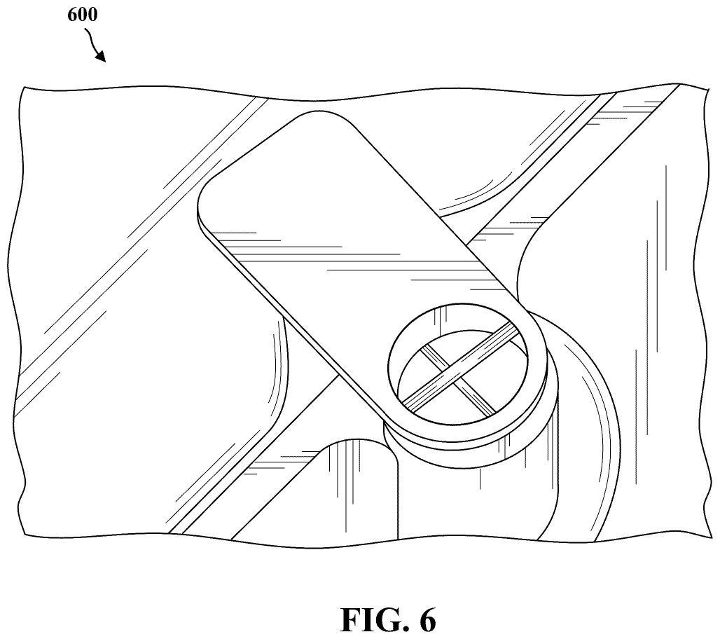

FIG. 6 is a diagram illustrating a portion 600 of the example structure 300 of FIG. 3. More specifically, FIG. 6 illustrates two examples of the hot melt retention feature, e.g., mechanical features 210, 212 that mate together. The mechanical features 210, 212 are both single bars or shafts. The single bars or shafts are each formed across a respective circular opening, each circular opening (and the corresponding bar or shaft) forms a respective retention feature. Glue or adhesive may be placed between the mechanical feature 210 and the mechanical feature 212. The glue or adhesive may flow in between portions of the mechanical feature 210 and the mechanical feature 212 and may bind to the portions of the mechanical feature 210 and the mechanical feature 212. For example, the glue or adhesive may bind to the single bar retention features.

In an aspect, a means for additively manufacturing a first AM part 202 may include a 3-D printer system (e.g., PBF system 100 of FIGS. 1A-1D) or another additively manufacturing system. The means for additively manufacturing a first AM part may manufacture the first AM part 202 configured to connect to a second part 204 via a primary connection 206 applied to an interface 208 between the first AM part 202 and the second part 204.

In an aspect, a means for attaching the second part 204 to the first AM part 202 may include a mechanical device or devices (such as one or more manufacturing robot) for attaching the second part 204 to the first AM part 202. For example, the manufacturing robot(s) may locate the second part 204 proximal to the first AM part 202.

In an aspect, one or more manufacturing robot(s) may apply one or more adhesives to one or more retention elements. Accordingly, in an aspect, a means for applying the first adhesive may include one or more manufacturing robot(s). For example, a dedicated robot (or robots) may be used to apply adhesive(s). In another example, the one or more manufacturing robot used for attaching the second part 204 to the first AM part 202 may also be configured to apply adhesive(s). Accordingly, the means for applying the first adhesive may include aspects of the for attaching the second part 204 to the first AM part 202 that apply the adhesive(s).

Manufacturing robot(s) may attach the second part 204 to the first AM part 202 using at least one retention element 210 including a secondary connection 302. The secondary connection 302 may include a first adhesive configured to secure the first AM part 202 and the second part 204. The secondary connection 302 may be located to provide a connection between the first AM part 202 and the second part 204.

A means for applying the first adhesive may be configured to apply the first adhesive during one of application of the second adhesive, during curing of the second adhesive, prior to application of the second adhesive, and/or prior to curing of the second adhesive. In an aspect, the adhesive(s) may be applied to secure the first AM part and the second part during application of the second adhesive. In an aspect, the adhesive(s) may be applied to secure the first AM part and the second part during curing of the second adhesive.

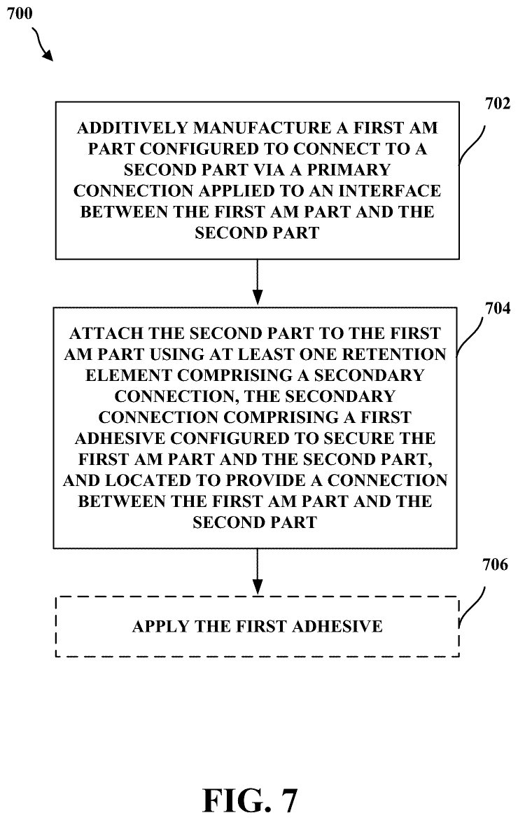

FIG. 7 is a flow diagram 700 of an exemplary process for adhering an AM structure with another structure. The exemplary process for adhering an AM structure with another structure may be implemented, at least in part, using an exemplary 3-D printer system. Some aspects may be implemented using other tools, systems, or devices, as is discussed herein. For example, one a 3-D printer system may be the PBF system 100 discussed in FIGS. 1A-1D.

In an aspect, block 702 includes additively manufacturing a first AM part. For example, a 3-D printer system or another additively manufacturing system additively manufacturing a first AM part configured to connect to a second part. The first AM part may be connected to the second part via a primary connection applied to an interface between the first AM part and the second part. For example, block 702 includes a 3-D printer system (e.g., PBF system 100) or another additively manufacturing system additively manufacturing a first AM part 202 configured to connect to a second part 204. The first AM part 202 may be connected to the second part 204 via a primary connection 206 applied to an interface 208 between the first AM part 202 and the second part 204. In some aspects, the second part may include, for example, an AM part, a tube, a panel, an extrusion, any other type of conventionally-manufactured part, or a COTS part. Accordingly, in some aspects, a 3-D printer system or another additively manufacturing system may manufacture the second part. (The manufacture of the second part is not necessarily part of the implemented method.)

In an aspect, block 704 includes attaching the second part to the first AM. For example, a mechanical device (such as a manufacturing robot) and/or an individual (or individuals) may attach the second part to the first AM part using at least one retention element including a secondary connection. The secondary connection may include a first adhesive configured to secure the first AM part and the second part. Additionally, the adhesive may be located to provide a connection between the first AM part and the second part. For example, the second part 204 may be attached to the first AM part 202 using at least one retention element 210 including a secondary connection 302. The secondary connection 302 may include a first adhesive configured to secure the first AM part 202 and the second part 204. Additionally, the adhesive may be located to provide a connection between the first AM part 202 and the second part 204.

As indicated in block 702, the secondary connection 302 may include a first adhesive. Accordingly, in block 704 the first adhesive may be applied. For example, a mechanical device (such as a manufacturing robot) and/or an individual (or individuals) may apply the first adhesive. In an aspect, the first adhesive is faster curing than the second adhesive. An aspect may include applying the first adhesive during application of the second adhesive. Another aspect may include applying the first adhesive during curing of the second adhesive. Another aspect may include applying the first adhesive prior to application of the second adhesive. Another aspect may include applying the first adhesive prior to curing of the second adhesive. Another aspect may include applying the first adhesive to secure the first AM part and the second part during application of the second adhesive. Another aspect may include applying the first adhesive to secure the first AM part and the second part during curing of the second adhesive.

The first adhesive may include a hot melt material applied between a first mechanical feature (e.g., mechanical structure 218) associated with the first AM part 202 and a second mechanical feature (e.g., mechanical structure 220) associated with the second part 204.

In an aspect, the first adhesive comprises a UV cured adhesive applied between a first mechanical feature (e.g., mechanical structure 218) associated with the first AM part 202 and a second mechanical feature (e.g., mechanical structure 220) associated with the second part 204.

In an aspect, the primary connection between the first AM part 202 and the second part 204 may include a second adhesive.

In an aspect, the secondary connection may further include a mechanical structure such as mechanical structure 218, 220, or mechanical-based part retention such as a groove that retains a snap-ring, a screw and shim, spring-loaded clips, clips, a snap-like part retention element, a snap-like part retention feature slidably engaging with a receptacle on an another part, a Christmas tree fastener, magnets, a tongue and groove connection, or other mechanical-based connections.

In an aspect, the mechanical structure (e.g., mechanical structure 218, 220) is integrated with at least one of the first AM part 202 and the second part 204.

In an aspect, the mechanical structure (e.g., mechanical structure 218, 220) is co-printed with at least one of the first AM part 202 and the second part 204.

In an aspect, the mechanical structure (e.g., mechanical structure 218, 220) is separate from the first AM part 202 and the second part 204. For example, the mechanical structure (e.g., mechanical structure 218, 220) may be separately manufactured from the first AM part 202 and/or the second part 204. One of the mechanical structures (e.g., mechanical structure 218, 220) may then be attached to the first AM part 202 or the second part 204. Accordingly, as used with respect to mechanical structure 218, 220, “separate” may mean manufactured separately rather than not being attached together.

The previous description is provided to enable any person skilled in the art to practice the various aspects described herein. Various modifications to these exemplary embodiments presented throughout this disclosure will be readily apparent to those skilled in the art, and the concepts disclosed herein may be applied to apparatus for adhesive-based part retention features in additively manufactured structures. Thus, the claims are not intended to be limited to the exemplary embodiments presented throughout the disclosure but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A structure, comprising:
a first additively manufactured (AM) part configured to connect to a second part via a primary connection applied to an interface between the first AM part and the second part; and
at least one retention element comprising a secondary connection, the secondary connection comprising a first adhesive configured to secure the first AM part and the second part, and located to provide a connection between the first AM part and the second part.

2. The structure of claim 1, wherein the first adhesive comprises a hot melt material applied between a first mechanical feature associated with the first AM part and a second mechanical feature associated with the second part.

3. The structure of claim 1, wherein the first adhesive comprises an ultraviolet (UV) cured adhesive applied between a first mechanical feature associated with the first AM part and a second mechanical feature associated with the second part.

4. The structure of claim 1, wherein the primary connection between the first AM part and the second part comprises a second adhesive.

5. The structure of claim 4, wherein the first adhesive is faster curing than the second adhesive.

6. The structure of claim 1, wherein the secondary connection further comprises a mechanical structure.

7. The structure of claim 6, wherein the mechanical structure is integrated with at least one of the first AM part and the second part.

8. The structure of claim 6, wherein the mechanical structure is co-printed with at least one of the first AM part and the second part.

9. The structure of claim 6, wherein the mechanical structure is separate from the first AM part and the second part.

10. A method, comprising:
additively manufacturing a first additively manufactured (AM) part configured to connect to a second part via a primary connection applied to an interface between the first AM part and the second part; and
attaching the second part to the first AM part using at least one retention element comprising a secondary connection, the secondary connection comprising a first adhesive configured to secure the first AM part and the second part, and located to provide a connection between the first AM part and the second part.

11. The method of claim 10, wherein the first adhesive comprises a hot melt material applied between a first mechanical feature associated with the first AM part and a second mechanical feature associated with the second part.

12. The method of claim 10, wherein the first adhesive comprises an ultraviolet (UV) cured adhesive applied between a first mechanical feature associated with the first AM part and a second mechanical feature associated with the second part.

13. The method of claim 10, wherein the primary connection between the first AM part and the second part comprises a second adhesive.

14. The method of claim 13, wherein the first adhesive is faster curing than the second adhesive.

15. The method of claim 13, further comprising applying the first adhesive during application of the second adhesive.

16. The method of claim 13, further comprising applying the first adhesive during curing of the second adhesive.

17. The method of claim 13, further comprising applying the first adhesive prior to application of the second adhesive.

18. The method of claim 13, further comprising applying the first adhesive prior to curing of the second adhesive.

19. The method of claim 13, further comprising applying the first adhesive to secure the first AM part and the second part during application of the second adhesive.

20. The method of claim 13, further comprising applying the first adhesive to secure the first AM part and the second part during curing of the second adhesive.

21. The method of claim 10, wherein the secondary connection further comprises a mechanical structure.

22. The method of claim 21, wherein the mechanical structure is integrated with at least one of the first AM part and the second part.

23. The method of claim 21, wherein the mechanical structure is co-printed with at least one of the first AM part and the second part.

24. The method of claim 21, wherein the mechanical structure is separate from the first AM part and the second part.
